(19) United States
(12) Patent Application Publication
(10) Pub. No.: US 2017/0097546 A1
(43) Pub. Date: Apr. 6, 2017

(54) LIQUID CRYSTAL DISPLAY DEVICE

(71) Applicant: SAMSUNG DISPLAY CO., LTD., Yongin-si (KR)

(72) Inventors: Israel Esteban LAZO MARTINEZ, Hwaseong-si (KR); Heung Shik PARK, Seoul (KR); Ki Chul SHIN, Seongnam-si (KR)

(21) Appl. No.: 15/146,316

(22) Filed: May 4, 2016

(30) Foreign Application Priority Data
Oct. 1, 2015 (KR) 10-2015-0138524

(51) Int. Cl. G02F 1/1343; G02F 1/1362; G02F 1/1368; G02F 1/1335

(52) U.S. Cl. CPC G02F 1/134309; G02F 1/133514; G02F 1/136286; G02F 1/1368; G02F 2001/134345

(57) ABSTRACT

A liquid crystal display device includes a first data line in a first direction a first gate line in a second direction, and a first pixel part connected to the first gate and data lines. The first pixel part includes a first sub-pixel part including a first sub-pixel electrode overlapping a first common electrode, and a second sub-pixel part including a second sub-pixel electrode overlapping a second common electrode. The first sub-pixel part includes a first switching element connected to the first data line and the first sub-pixel electrode, the second sub-pixel part includes a second switching element connected to the data line and the second sub-pixel electrode, and a level of a voltage applied to the first common electrode is different from a level of a voltage applied to the second common electrode.

This application claims priority to Korean Patent Application No. 10-2015-0138524, filed on Oct. 1, 2015, and all the benefits accruing therefrom under 35 U.S.C. §119, the content of which in its entirety is herein incorporated by reference.

### BACKGROUND

1. Field

Exemplary embodiments of the invention relate to a liquid crystal display device.

2. Description of the Related Art

A liquid crystal display device is one of the most widely used types of flat panel display device. The liquid crystal display device typically includes two substrates including a field generating electrode such as a pixel electrode and a common electrode, and a liquid crystal layer disposed therebetween. The liquid crystal display device generates an electric field in the liquid crystal layer by applying a voltage to the field generating electrode, thereby displaying an image by determining the directions of the liquid crystal molecules of the liquid crystal layer and controlling the polarization of incident light.

Among the liquid crystal display devices, a liquid crystal display device of a vertically aligned mode, in which the longitudinal axes of liquid crystal molecules are aligned to be perpendicular to a display panel in a state where an electric field is not applied, has been developed. The liquid crystal display device of the vertically aligned mode has been developed in various structures, including a structure in which a single pixel part is divided into two sub-pixel parts for ensuring the side visibility.

### SUMMARY

Exemplary embodiments of the invention relate to a liquid crystal display device with improved aperture ratio, by not using a separate voltage dividing switching element and a contact hole connected thereto.

According to an exemplary embodiment of the invention, a liquid crystal display device includes: a first data line disposed in a first direction: a first gate line disposed in a second direction different from the first direction: and a first pixel part connected to the first data line and the first gate line. In such an embodiment, the first pixel part includes a first sub-pixel part including a first sub-pixel electrode overlapping a first common electrode, and a second sub-pixel part including a second sub-pixel electrode overlapping a second common electrode. In such an embodiment, the first sub-pixel part includes a first switching element, in which a gate electrode of the first switching element is connected to the first gate line, an electrode of the first switching element is connected to the first data line, and another electrode of the first switching element is connected to the first sub-pixel electrode. In such an embodiment, the second sub-pixel part includes a second switching element, in which a gate electrode of the second switching element is connected to the first gate line, an electrode of the second switching element is connected to the first data line, and another electrode of the second switching element is connected to the second sub-pixel electrode. In such an embodiment, a level of a voltage applied to the first common electrode is different from a level of a voltage applied to the second common electrode.

According to an exemplary embodiment of the invention, a liquid crystal display device includes: a first substrate; a second substrate disposed opposite to the first substrate; a plurality of data lines disposed on the first substrate and extending in a first direction; a plurality of gate lines disposed on the first substrate and extending in a second direction different from the first direction; a plurality of pixel parts connected to the plurality of data lines and the plurality of gate lines; and first and second common electrodes disposed on the second substrate. In such an embodiment, the plurality of pixel parts includes a first pixel part including a first sub-pixel part overlapping the first common electrode, and a second sub-pixel part overlapping the second common electrode, and a level of a voltage applied to the first common electrode is different from a level of a voltage applied to the second common electrode.

### BRIEF DESCRIPTION OF THE DRAWINGS

The above and other features of the invention will become more apparent by describing in further detail exemplary embodiments thereof with reference to the accompanying drawings, in which:

FIG. 1 is a schematic diagram illustrating a liquid crystal display device according to an embodiment of the invention;

FIG. 2 is an equivalent circuit diagram illustrating first to fourth pixel parts, of a display panel illustrated in FIG. 1;

FIG. 3 is a plan view illustrating the first pixel part of the display panel illustrated in FIG. 1 in more detail;

FIG. 4 is a cross-sectional view taken along line I1-I1′ of FIG. 3;

FIG. 5 is a cross-sectional view taken along line I2-I2′ of FIG. 3;

FIG. 6 is a plan view illustrating first to fourth pixel parts of the display panel illustrated in FIG. 1;

FIG. 7 is a diagram for illustrating a driving method of a liquid crystal display device according to an embodiment of the invention using the first pixel part as an example;

FIG. 8 is a diagram for illustrating a driving method of the first to fourth pixel parts, of the display panel illustrated in FIG. 1;

FIGS. 9 to 11 are diagrams for illustrating an effect of the liquid crystal display device according to an embodiment of the invention;

FIG. 12 is a plan view for illustrating a liquid crystal display device according to an alternative embodiment of the invention;

FIG. 13 is an equivalent circuit diagram illustrating the first to fourth pixel parts, of the liquid crystal display device illustrated in FIG. 12;

FIG. 14 is a plan view illustrating the first pixel part of the liquid crystal display device according to another alternative embodiment of the invention;

FIG. 15 is a diagram illustrating the first and second sub-pixel electrodes of the liquid crystal display device according to another alternative embodiment of the invention;

FIGS. 16A and 16B are diagrams illustrating first and second common electrodes CE1, CE2 corresponding to another alternative embodiment of the first and second sub-pixel electrode PE1, PE2 illustrated in FIG. 15; and

FIGS. 17A and 17B are diagrams illustrating first and second common electrodes corresponding to another alternative embodiment of the first and second sub-pixel electrodes illustrated in FIG. 15.

### DETAILED DESCRIPTION

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Or” means “and/or.” As used herein, the term “and/or” includes any and all combinations of one or more of the associated listed items. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments will be described with reference to the accompanying drawings.

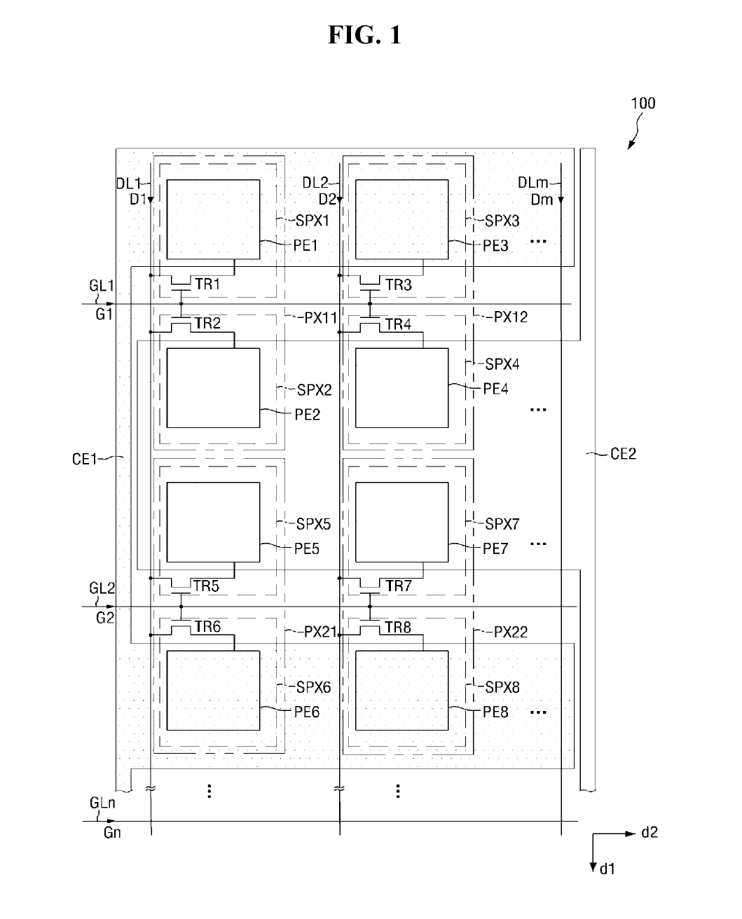

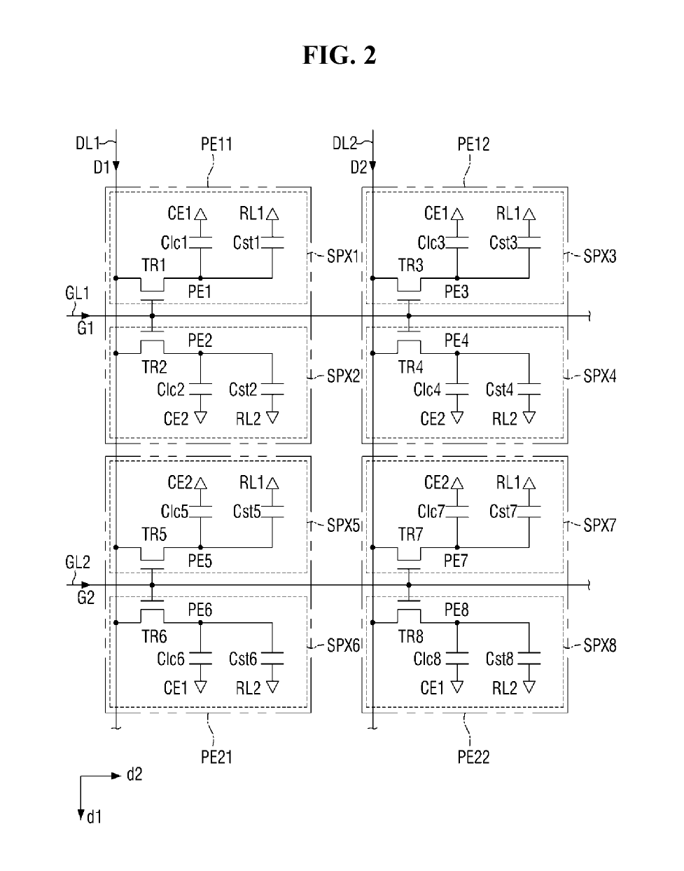

FIG. 1 is a schematic diagram illustrating a liquid crystal display device according to an embodiment of the invention. FIG. 2 is an equivalent circuit diagram of first to fourth pixel parts PX11, PX12, PX21, PX22 of a display panel 100 illustrated in FIG. 1.

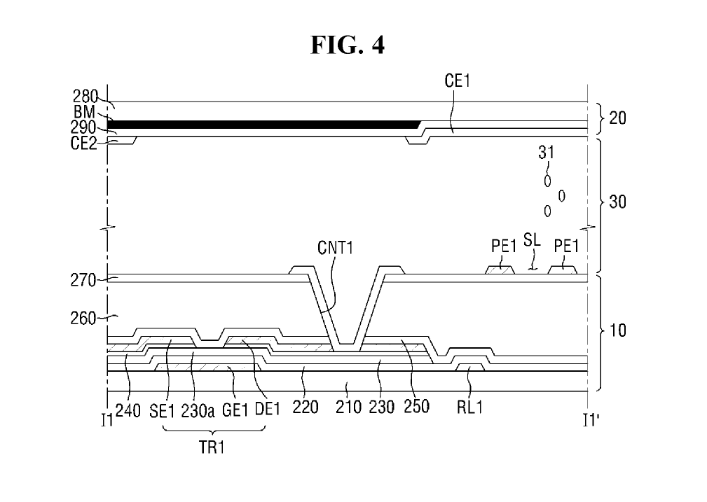

First, referring to FIG. 1, the liquid crystal display device according to an embodiment of the invention may include a display panel 100. The display panel 100 is a panel that displays an image. In an embodiment, the display panel 100 may include a lower display panel (210, see FIG. 4), an upper display panel 280 facing the lower display panel (210, see FIG. 4) and a liquid crystal layer (30, see FIG. 4) interposed therebetween. In such an embodiment, the display panel 100 may be a liquid crystal panel.

The display panel 100 is connected to first to n-th gate lines (GL1 to GLn, n is a natural number of 1 or greater) and first to m-th data lines (DL1 to DLm, m is a natural number of 1 or greater). The first to n-th gate lines GL1 to GLn and the first to m-th data lines DL1 to DLm may be disposed in a lower display panel 10 of the display panel 100, and the respective lines are insulated from one another. The first through m-th data lines DL1 to DLm may be disposed to extend in a first direction d1, and the first to n-th gate lines GL1 to GLn may be disposed to extend in a second direction d2 crossing the first direction d1.

The display panel 100 may include a plurality of pixel parts including first to fourth pixel parts PX11, PX12, PX21, PX22. In an embodiment, as described above, the plurality of pixel parts may be disposed in a matrix form. In such an embodiment, the first direction d1 may be a column direction, and the second direction d2 may be a row direction, as shown in FIG. 1. Hereinafter, the first through fourth pixel parts PX11, PX12, PX21, PX22 among the plurality of pixel parts will be described in detail for convenience of description.

Referring to FIG. 2, the first pixel part PX11 may include first and second sub-pixel parts SPX1, SPX2. Each of the first and second sub-pixel parts SPX1, SPX2 may be connected to both of the first gate line GL1 and the first data line DL1. In such an embodiment, the first and second sub-pixel parts SPX1, SPX2 may receive a data signal through a first data signal D1 to display images according to gamma curves different from each other or express images according to the same gamma curve. Thus, the first and second sub-pixel parts SPX1, SPX2 may display the images having luminances different from each other based on a same data signal, thereby improving the side visibility.

The first sub-pixel part SPX1 may include a first switching element TR1 and a first sub-pixel electrode PE1.

The first switching element TR1 may be a transistor, for example. The first switching element TR1 may be configured so that a gate electrode thereof is connected to the first gate line GL1, one electrode thereof is connected to the first data line DL1, and the other electrode thereof is connected to the first sub-pixel electrode PE1. Hereinafter, an embodiment, where the one electrode of the first switching element TR1 is a source electrode and the other electrode is a drain electrode, will be described in detail for convenience of description. The first switching element TR1 is turned on in response to the first gate signal G1 provided from the first gate line GL1, and may provide the first data signal D1 provided from the first data line DL1 to the first sub-pixel electrode PE1. In an embodiment, the first sub-pixel part SPX1 may be superimposed with or overlapping at least a part of the first common electrode CE1. The first sub-pixel part SPX1 may receive a first common voltage Vcom1 through the first common electrode CE1.

The first sub-pixel part SPX1 may further include a first liquid crystal capacitor Clc1 formed between the first sub-pixel electrode PE1 and the first common electrode CE1. Thus, the first liquid crystal capacitor Clc1 may be charged with a voltage corresponding to a voltage difference between the voltage applied to the first sub-pixel electrode PE1 and the first common voltage Vcom1.

In an embodiment, the first sub-pixel part SPX1 may further include a first storage capacitor Cst1 which is charged with a voltage corresponding to a voltage difference between the voltage provided from the first storage line RL1 and the voltage applied to the first sub-pixel electrode PE1.

The second sub-pixel part SPX2 may include a second switching element TR2 and a second sub-pixel electrode PE2.

The second switching element TR2 may be a transistor, for example. The second switching element TR2 may be configured so that a gate electrode thereof is connected to the first gate line GL1, one electrode thereof is connected to the first data line DL1, and the other electrode thereof is connected to the second sub-pixel electrode PE2. In an embodiment, the one electrode of the second switching element TR2 may be a source electrode, and the other electrode may be an electrode. The second switching element TR2 is turned on in response to the first gate signal G1 provided from the first gate line GL1, and may provide the first data signal D1 provided from the first data line DL1 to the second sub-pixel electrode PE2. In such an embodiment, the second sub-pixel part SPX2 may be superimposed with or overlapping at least a part of the second common electrode CE2. The second sub-pixel part SPX2 may receive a second common voltage Vcom2 through second common electrode CE2.

The second sub-pixel part SPX2 may further include a second liquid crystal capacitor Clc2 formed between the second sub-pixel electrode PE2 and the second common electrode CE2. Thus, the second liquid crystal capacitor Clc2 may be charged with a voltage corresponding to a voltage difference between the voltage applied to the second sub-pixel electrode PE2 and the second common voltage Vcom2.

In an embodiment, the first common electrode CE1 and the second common electrode CE2 may be disposed to be electrically insulated from each other. In such an embodiment, each of the first common voltage Vcom1 applied to the first common electrode CE1 and the second common voltage Vcom2 applied to the second common electrode CE2 is a substantially constant voltage or in a direct-current (“DC”) form. In such an embodiment, the first common voltage Vcom1 applied to the first common electrode CE1 and the second common voltage Vcom2 applied to the second common electrode CE2 may have different voltage levels from each other. In an embodiment, the voltage level of the first common voltage Vcom1 may be lower than the voltage level of the second common voltage Vcom2.

In such an embodiment, where the first common voltage Vcom1 and the second common voltage Vcom2 have different voltage levels from each other, a level of the voltage charged to the first liquid crystal capacitor Clc1 and a level of the voltage charged to the second liquid crystal capacitor Clc2 may be different from each other. If the voltage level of the first common voltage Vcom1 is lower than the voltage level of the second common voltage Vcom2, the level (the voltage level) of the voltage charged to the first liquid crystal capacitor Clc1 may be higher than the level of the voltage charged to the second liquid crystal capacitor Clc2. In one exemplary embodiment, for example, the first common voltage Vcom1 may be about 7.5 volts (V), and the second common voltage Vcom2 may be about 8.5 V.

In such an embodiment, even when the first and second sub-pixel parts SPX1, SPX2 receive the same first data signal D1 from the first data line DL1, the level of the voltage charged to the first liquid crystal capacitor Clc1 and the level of the voltage charged to the second liquid crystal capacitor Clc2 may be different from each other. Thus, since tilting angles of liquid crystal molecules of the first and second sub-pixel parts SPX1, SPX2 are different, the side visibility may be improved. In such an embodiment, the liquid crystal display device may not use a switching element for voltage distribution, and a separate additional contact hole for applying a distributed voltage to the switching element. Thus, the liquid crystal display device according to an embodiment of the invention may have improved aperture ratio.

In one exemplary embodiment, for example, the first sub-pixel electrode PE1 may have the same area as the second sub-pixel electrode PE2. In an embodiment, the second sub-pixel part SPX2 may further include a second storage capacitor Cst2 to which a voltage having a potential difference between the level of the voltage provided from the second storage line RL2 and the level of the voltage applied to the second sub-pixel electrode PE2. In such an embodiment, the voltage of the same level may be applied to each of the first storage line RL1 and the second storage line RL2.

The second pixel part PX12 may include third and fourth sub-pixel part SPX3, SPX4. Each of the third and fourth sub-pixel parts SPX3, SPX4 may be connected to the first gate line GL1, and may also be connected to the second data line DL2 disposed to be adjacent to the first data line DL1. Herein, tow lines are defined as being adjacent to each other when no line is disposed between the two lines. The third sub-pixel part SPX3 may include a third switching element TR3 and a third sub-pixel electrode PE3, and the fourth sub-pixel part SPX4 may include a fourth switching element TR4 and a fourth sub-pixel electrode PE4. In such an embodiment, the third sub-pixel part SPX3 may be superimposed with or overlapping at least a part of the first common electrode CE1, and the fourth sub-pixel parts SPX4 may be superimposed with or overlapping at least a part of the second common electrode CE2. Thus, the third sub-pixel part SPX3 may receive the first common voltage Vcom1 from the first common electrode CE1, and the fourth sub-pixel part SPX4 may receive the second common voltage Vcom2 from the second common electrode CE2.

In such an embodiment, the second pixel part PX12 is different from the first pixel part PX11 only in the interconnected data lines, and the remaining configurations may be substantially the same as each other. In such an embodiment, in addition to the first and second pixel parts PE11, PE12, the pixel parts connected to a same gate line (e.g., the first gate line GL1) differs only in the interconnected data lines, and the configuration in the pixel part and a superimposed structure with the common electrode may be identical to each other.

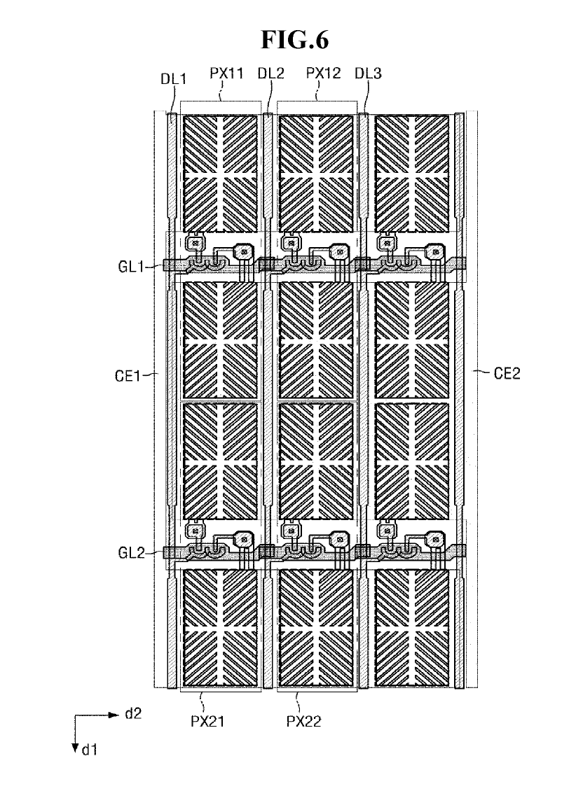

In an embodiment, the data signals with the polarities different from each other may be applied to the data lines adjacent to each other. In one exemplary embodiment, for example, when the polarity of the first data signal D1 provided through the first data line DL1 is a positive polarity (+), the polarity of the second data signal D2 supplied through the second data line DL2 disposed to be adjacent to the first data line DL1 may be a negative (−) polarity. This will be described in greater detail below referring to FIG. 6.

The third pixel part PX21 may be connected to the second gate line GL2 and the first data line DL1. The third pixel part PX21 may include fifth and sixth sub-pixel parts SPX5, SPX6. Each of the fifth and sixth sub-pixel parts SPX5, SPX6 may be connected to the second gate line GL2 and the first data line DL1. The fifth sub-pixel part SPX5 may include a fifth switching element TR5 and a fifth sub-pixel electrode PE5. The sixth sub-pixel part SPX6 may include a sixth switching element TR6 and a sixth sub-pixel electrode PE6. The fifth sub-pixel part SPX5 may be superimposed with or overlapping at least a part of the second common electrode CE2, and the sixth sub-pixel part SPX6 may be superimposed with or overlapping at least a part of the first common electrode CE1. Thus, the fifth sub-pixel part SPX5 may receive the second common voltage Vcom2 from the second common electrode CE2, and the sixth sub-pixel part SPX6 may receive the first common voltage Vcom1 from the first common electrode CE1.

Therefore, the level of the voltage charged to the fifth liquid crystal capacitor Clc5 in the fifth sub-pixel part SPX5 located in the relatively upper part on the basis of FIG. 1 may be lower than the level of the voltage charged to the sixth liquid crystal capacitor Clc6 in the sixth sub-pixel part SPX6.

The fourth pixel part PX22 may be connected to each of the second gate line GL2 and the second data line DL2. Since the third and fourth pixel parts PX21, PX22 are connected to the same second gate line GL2 and a connection relation of the data lines is different from each other, the configuration in the pixel part and the superimposed structure with the common electrode may be identical to each other.

In an embodiment, data signals with polarities different from each other may be applied between the pixel parts disposed in each of the gate lines adjacent to each other. That is, the data signals with the different polarities may be applied between the pixel parts adjacent to each other. In one exemplary embodiment, for example, when the data signal of the positive polarity (+) is applied to the first pixel part PX11, the data signal of the negative polarity (−) may be applied to the second and third pixel parts PX12, PX21. Furthermore, the data signal of the positive polarity (+) may be applied to the fourth pixel part PX22. This will be described later, referring to FIG. 6.

In an embodiment, the liquid crystal display device may a plurality of pixel parts, each including two sub-pixel parts superimposed with or overlapping the first and second common electrodes CE1, CE2, respectively.

In such an embodiment, as voltage levels of DC voltages or substantially constant voltages (e.g., the first and second common voltages Vcom1 and Vcom2) applied to the first and second common electrodes CE1, CE2 are different from each other, the two sub-pixel parts may include a liquid crystal capacitor that is charged with voltages of different levels from each other. Thus, in such an embodiment, a separate voltage distributing switching element and a contact hole for distributing the voltage in the voltage distributing switching element may be omitted, such that the liquid crystal display device may have an improved aperture ratio.

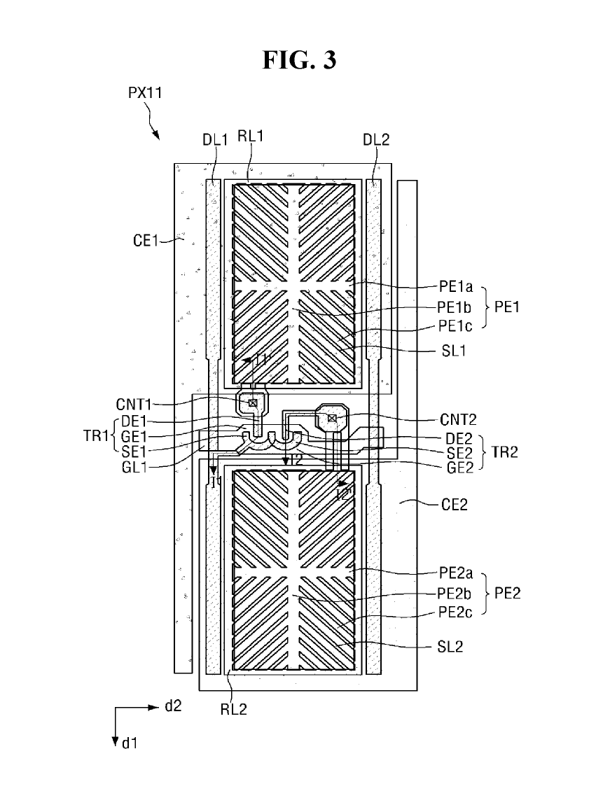

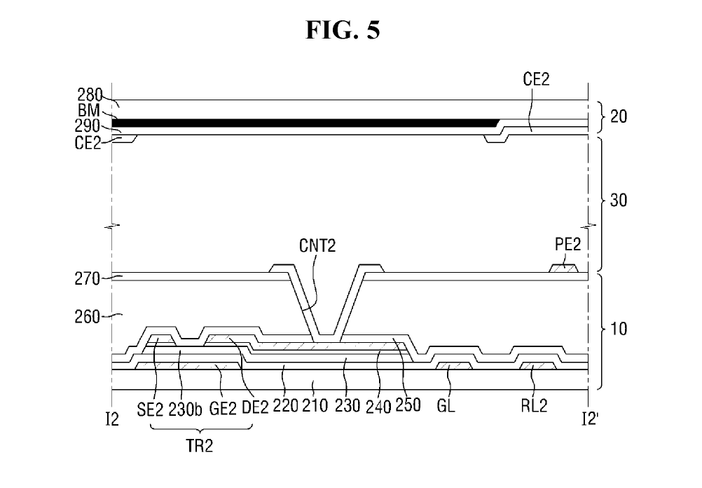

FIG. 3 is a plan view illustrating a first pixel part PX11 of the display panel 100 illustrated in FIG. 1. FIG. 4 is a cross-sectional view taken along line I1-I1′ of FIG. 3. FIG. 5 is a cross-sectional view taken along line I2-I2′ of FIG. 3.

For convenience of description, only the first pixel part PX11 among the pixel parts of the display panel 100 will be described in greater detail, referring to FIGS. 3 to 5. In an embodiment, the liquid crystal display device may include a lower display panel 10, an upper display panel 20 and a liquid crystal layer 30 interposed therebetween. The lower display panel 10 may be disposed to opposite to, e.g., face, the upper display panel 20. In one embodiment, for example, the lower display panel 10 may be joined to the upper display panel 20 through sealing.

First, the lower display panel 10 will be described.

A lower substrate 210 may be a transparent glass substrate, a plastic substrate or the like, and may be an array substrate on which a plurality of switching elements is disposed. In such an embodiment, a first gate line GL1, a first storage line RL1 and a second storage line RL2 may be disposed on the lower substrate 210. In such an embodiment, all of the first gate line GL1, the first storage line RL1 and the second storage line RL2 may be disposed in a same layer or directly on a same layer. The first gate line GL1 may include first and second gate electrodes GE1, GE2.

In such an embodiment, the first gate electrode GE1 may protrude or extend toward the first semiconductor pattern 230a from a side of the first gate line GL1, and the second gate electrode GE2 may protrude or expand toward the second semiconductor pattern 230b from a side of the first gate line GL1. The first storage line RL1 may be disposed above the first gate line GL1 in a top plan view as shown in FIG. 3, and the second storage line RL2 may be disposed below the first gate line GL1 in the top plan view as shown in FIG. 3. Herein, the top plan view is a view shown in a thickness direction of the display panel 100. The first and second storage lines RL1, RL2 may be electrically connected to each other, and the same voltage may be applied thereto in an embodiment.

In an embodiment, the first gate line GL1, the first storage line RL1 and the second storage line RL2 may have a single film structure and may include a conductive metal including at least one selected from aluminum (Al), copper (Cu), molybdenum (Mo), chromium (Cr), titanium (Ti), tungsten (W), moly-tungsten (MoW), moly-titanium (MoTi) and copper/moly-titanium (Cu/MoTi). In an alternative embodiment, the first gate line GL1, the first storage line RL1 and the second storage line RL2 may have a double film structure formed by at least two elements described above, or a triple film structure formed by three elements.

The gate insulating film 220 may be disposed on the first gate line GL1, the first storage line RL1 and the second storage line RL2. The gate insulating film 220 may include or be formed of silicon nitride (SiNx) or silicon oxide (SiOx) in an embodiment. The gate insulating film 220 may also have a multi-film structure including at least two insulating films having different physical characteristics.

In an embodiment, the semiconductor layer 230 may be disposed on the gate insulating film 220, and may include an amorphous silicon, a polycrystalline silicon or the like. Alternatively, the semiconductor layer 230 may include an oxide semiconductor including at least one selected from indium gallium zinc oxide (“IGZO”), ZnO, ZnO₂, CdO, SrO, SrO₂, CaO, CaO₂, MgO, MgO₂, InO, In₂O₂, GaO, Ga₂O, Ga₂O₃, SnO, SnO₂, GeO, GeO₂, PbO, Pb₂O₃, Pb₃O₄, TiO, TiO₂, Ti₂O₃ and Ti₃O₅. The semiconductor layer 230 may be disposed to be at least partially superimposed with or overlapping the first data line DL1. In an embodiment, where a plurality of data lines, a first source electrode SE1, a second source electrode SE2, a drain electrode DE1, a second drain electrode DE2 and a semiconductor layer 230 are formed together through a single mask process, the semiconductor layer 230 may be disposed at the bottom of a structure defined by the elements above. In such an embodiment, the semiconductor layer 230 may have substantially the same shape as the source and drain electrodes, with the exception of a channel region of the switching element.

The semiconductor layer 230 may include a first semiconductor pattern 230a that forms the first switching element TR1, and a second semiconductor pattern 230b that forms the second switching element TR2. The first semiconductor pattern 230a is disposed to be at least partially superimposed with or overlapping the first gate electrode GE1, and the second semiconductor pattern 230b is disposed to be at least partially superimposed with or overlapping the second gate electrode GE2.

An ohmic contact layer 240 may be disposed on the semiconductor layer 230. The ohmic contact layer 240 may include or be made of a material such as n+ hydrogenated amorphous silicon doped with n-type impurity such as phosphorus at high concentration, or made of silicide. In an alternative embodiment, the ohmic contact layer 240 may be omitted.

The first data line DL1, the second data line DL2, the first source electrode SE1, the second source electrode SE2, the first drain electrode DE1 and the second drain electrode DE2 may be disposed on the ohmic contact layer 240.

The first switching element TR1 includes a first source electrode SE1, a first drain electrode DE1, a first semiconductor pattern 230a and a first gate electrode GE1. The first source electrode SE1 is connected to the first data line DL1, and may receive the first data signal D1. The first drain electrode DE1 may be electrically connected to the first sub-pixel electrode PE1 through the first contact hole CNT1. The first source electrode SE1 and the first drain electrode DE1 may be disposed to be at least partially superimposed with or overlapping the first gate electrode GE1, and may be disposed on the first semiconductor pattern 230a and the ohmic contact layer 240, while being spaced apart from each other by a predetermined distance.

The second switching element TR2 includes a second source electrode SE2, a second drain electrode DE2, a second semiconductor pattern 230b and a second gate electrode GE2. The second source electrode SE2 is connected to the second data line DL2, and may receive the second data signal D2. The second drain electrode DE2 may be electrically connected to the second sub-pixel electrode PE2 through the second contact hole CNT2. The second source electrode SE2 and the second drain electrode DE2 may be disposed to be at least partially superimposed with or overlapping the second gate electrode GE2, and may be disposed on the semiconductor pattern 230b and the ohmic contact layer 240, while being spaced apart from each other by a predetermined distance.

The first sub-pixel part SPX1 may receive the first data signal D1 through the first source electrode SE1, and may apply the first data signal D1 to the first sub-pixel electrode PE1 through the first drain electrode DE1 and the first contact hole CNT1. The second sub-pixel part SPX2 may apply the first data signal D1 provided through the second source electrode SE2 of the second switching element TR2 to the second sub-pixel electrode PE2 through the second drain electrode DE2 and the second contact hole CNT2.

In an embodiment, the first data line DL1, the second data line DL2, the first source electrode SE1, the second source electrode SE2, the first drain electrode DE1 and the second drain electrode DE2 may have a single film structure including a conductive metal. In such an embodiment, the conductive metal may include at least one selected from aluminum (Al), copper (Cu), molybdenum (Mo), chromium (Cr), titanium (Ti), tungsten (W), moly-tungsten (MoW), moly-titanium (MoTi) and copper/moly-titanium (Cu/MoTi). Alternatively, the first data line DL1, the second data line DL2, the first source electrode SE1, the second source electrode SE2, the first drain electrode DE1 and the second drain electrode DE2 may have a double film formed by at least two of the elements listed above, or a triple film formed by three of the elements listed above. However, the invention is not limited thereto, and the first data line DL1, the second data line DL2, the first source electrode SE1, the second source electrode SE2, the first drain electrode DE1 and the second drain electrode DE2 may be made of various metals or conductors.

A first passivation film 250 may be disposed on the gate insulating film 220, to cover the first data line DL1, the second data line DL2, the first source electrode SE1, the second source electrode SE2, the first drain electrode DE1 and the second drain electrode DE2 disposed on the gate insulating film 220. The first passivation film 250 may include or be formed of an inorganic insulating material, such as a silicon nitride and a silicon oxide. The first passivation film 250 may effectively prevent pigment of a color filter 160 disposed on the first passivation film 250 from flowing into the exposed semiconductor layer 230.

The color filter 260 may be disposed on the first passivation film 250. The color filter 260 may display one of primary colors such as three primary colors of red, green and blue, but not being limited thereto. The color filter 260 may include or be formed of a material which displays different color for each pixel parts adjacent to each other.

A second passivation film 270 may be disposed on the color filter 260. The second passivation film 270 may include or be formed of an inorganic insulator or an organic insulator, such as a silicon nitride and a silicon oxide. The second passivation film 270 prevents the top of the color filter 260 from rising, and suppresses contamination of the liquid crystal layer 30 due to the organic material such as solvent which may be introduced from the color filter 260, thereby effectively preventing a defect such as a residual image that may be caused when driving a screen.

The first sub-pixel electrode PE1 is disposed on the second passivation film 270, and may be electrically connected to the exposed first drain electrode DE1 through the first contact hole CNT1. The second sub-pixel electrode PE2 is disposed on the second passivation film 270, and may be electrically connected to the exposed second drain electrode DE2 through a second contact hole CNT2. The first and second sub-pixel electrodes PE1, PE2 may include or be formed of a transparent conductive material such as indium tin oxide (“ITO”) and indium zinc oxide (“IZO”), or a reflective metal such as aluminum, silver, chromium or an alloy thereof.

The first sub-pixel electrode PE1 may include a first horizontal step portion PE1a that extends in a second direction d2, and a first vertical stem portion line PE1b that extends in a first direction d1. In an embodiment, the first sub-pixel electrode PE1 may further include a plurality of first branch portions PE1c that extends diagonally from each of the first horizontal stem portion PE1a and the first vertical stem portion PE1b. In an embodiment, the first sub-pixel electrode PE1 may further include a plurality of first slits ST1. The plurality of first slits ST1 forms a fringe field between the first sub-pixel electrode PE1 and a first common electrode CE1 to be described later, such that a plurality of liquid crystal molecules 31 in the liquid crystal layer 30 may rotate in a particular direction.

The second sub-pixel electrode PE2 may include a second horizontal stem portion PE2a that extends in the second direction d2, and a second vertical stem portion PE2b that extends in the first direction d1. In an embodiment, the second sub-pixel electrode PE2 may further include a plurality of second branch portions PE2c that extends diagonally from each of the second horizontal stem portion PE2a and the second vertical stem portion PE2b. In an embodiment, the first sub-pixel electrode PE1 may have substantially the same shape as the second sub-pixel electrode PE2.

In an embodiment, the second sub-pixel electrode PE2 may further include a plurality of second slits ST2. The plurality of second slits ST2 forms a fringe field between the second sub-pixel electrode PE2 and a second common electrode CE2 to be described later, such that a plurality of liquid crystal molecules 31 in the liquid crystal layer 30 may rotate in a particular direction.

In an embodiment, the liquid crystal display may further include a shield electrode (not illustrated). The shield electrode may be disposed to be superimposed with or overlapping each of first and second data lines DL1, DL2 on the second passivation film 180. In such an embodiment, the shield electrode may be disposed in or directly on the same layer as the first and second sub-pixel electrodes PE1, PE2. In such an embodiment, where the shield electrode is disposed to be superimposed with or overlapping each of the plurality of data lines, a light leakage phenomenon due to coupling between the pixel electrodes adjacent to the plurality of data lines may be effectively prevented. The shield electrode may be include or formed of a transparent conductive material such as ITO or IZO, or a reflective metal such as aluminum, silver, chromium or an alloy thereof in an embodiment.

Next, the upper display panel 20 will be described.

The upper substrate 280 may include or be formed of a transparent glass or plastic. A light-shielding member BM, that is also referred to as a black matrix and prevents light leakage, may be disposed on the upper substrate 280. An overcoat layer 290 may be disposed on the upper substrate 280 and the light-shielding member BM. The overcoat layer 290 may include or be formed of an insulating material. Alternatively, the overcoat layer 290 may be omitted.

The first and second common electrodes CE1, CE2 may be disposed on the overcoat layer 290. Based on the first pixel part PX11, the first common electrode CE1 may be disposed to be superimposed with or overlapping the first sub-pixel electrode PE1. Further, the second common electrode CE2 may be disposed to be superimposed with or overlapping the second sub-pixel electrode PE2.

In an embodiment, as described above, both of the first common voltage Vcom1 applied to the first common electrode CE1 and the second common voltage Vcom2 applied to the second common electrode CE2 are in the form of direct current or constant voltages. In such an embodiment, the levels of the first and second common voltages Vcom1, Vcom2 may be different from each other. In an embodiment, when the level of the first common voltage Vcom1 is lower than the level of the second common voltage Vcom2, the level of the voltage charged to the first liquid crystal capacitor Clc1 in the first sub-pixel part SPX1 may be may be higher than the level of the voltage charged to the second liquid crystal capacitor Clc2.

Thus, in such an embodiment, the alignment state of a plurality of liquid crystal molecules located between the first sub-pixel electrode PE1 and the first common electrode CE1 is different from the alignment state of a plurality of liquid crystal molecules located between the second sub-pixel electrode PE2 and the second common electrode CE2.

Thus, in the liquid crystal display device according to an embodiment of the invention, even when the first and second sub-pixel parts SPX1, PSX2 in the first pixel part PX11 receive the same first data signal D1, as the different voltage levels are charged to the respective liquid crystal capacitors, the side visibility may be improved.

FIG. 6 is a plan view illustrating a part of the display panel 100 illustrated in FIG. 1 in greater detail.

Referring to FIG. 6, each of the first to third pixel parts PX11, PX12, PX13 may be connected to the first gate line GL1. Further, among the respective pixel parts connected to the first gate line GL1, the sub-pixel part disposed above with reference to the first gate line GL1 may be disposed to be superimposed with or overlapping the first common electrode CE1, and the sub-pixel part disposed below with reference to the first gate line GL1 may be disposed to be superimposed with or overlapping the second common electrode CE2.

In such an embodiment, each of the pixel parts includes two sub-pixel parts, and the two sub-pixel parts may be disposed to be superimposed with or overlapping the common electrodes different from each other. In such an embodiment, the sub-pixel parts disposed in a same row may be disposed to be superimposed with or overlapping a same common electrode.

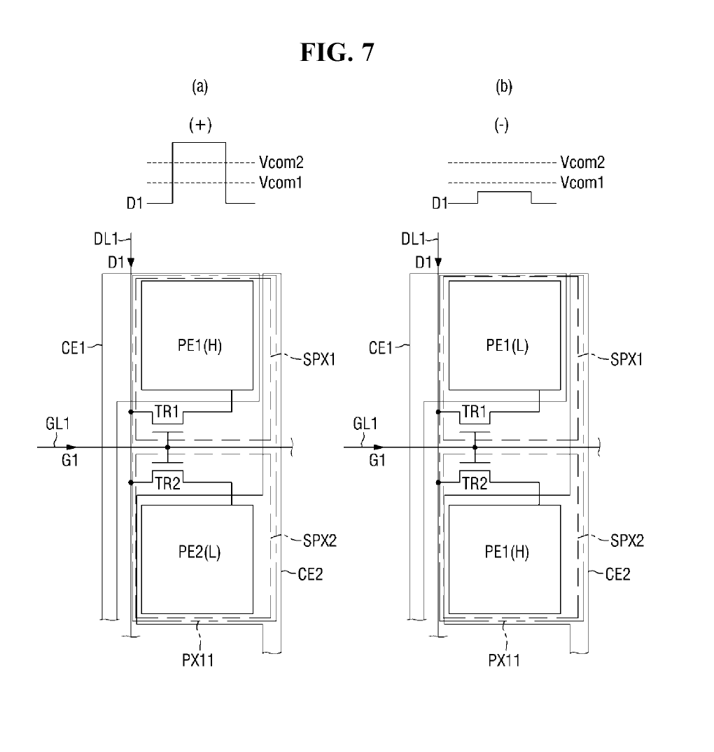

FIG. 7 is a diagram for explaining a driving method of the liquid crystal display device according to an embodiment of the invention based on the first pixel part PX11 as an example. FIG. 7(a) is a case where the first data signal D1 has a positive polarity (+), and FIG. 7(b) is a case where the first data signal D1 has a negative polarity (−). In an embodiment, the first and second common voltages Vcom1, Vcom2 are DC or constant voltages, and the level of the first common voltage Vcom1 may be lower than the level of the second common voltage Vcom2. In an embodiment, the sub-pixel electrode charged with a relatively high voltage is expressed by high (H), and the sub-pixel electrode charged with a relatively low voltage is expressed by low (L).

First, with reference to FIG. 7(a), in the first sub-pixel part SPX1, as the first switching element TR1 is turned on, the first data signal D1 of the positive polarity (+) may be applied to each of the first sub-pixel electrode PE1 and the second sub-pixel electrode PE2. The voltage level of the first data signal D1 of the positive polarity (+) may be higher than the levels of the first and second common voltages Vcom1, Vcom2. The first common voltage Vcom1 is applied to the first common electrode CE1 which is superimposed with or overlapping the first sub-pixel electrode PE1, and the second common voltage Vcom2 is applied to the second common electrode CE2 which is superimposed with or overlapping the second sub-pixel electrode PE2. Thus, a voltage difference between the voltage level of the first data signal D1 and the first common voltage Vcom1 is charged to the first liquid crystal capacitor Clc1 in the first sub-pixel part SPX1, and a voltage difference between the voltage level of the first data signal D1 and the second common voltage Vcom2 is charged to the second liquid crystal capacitor Clc2 in the second sub-pixel part SPX2. Therefore, the level of the voltage charged to the first liquid crystal capacitor Clc1 may be different from the level of the voltage charged to the second liquid crystal capacitor Clc2. In such an embodiment, since the level of the voltage charged to the first liquid crystal capacitor Clc1 is relatively high, the first sub-pixel electrode PE1 may be expressed by high (H). In this case, the second sub-pixel electrode PE2 may be expressed by low (L).

Referring to FIG. 7(b), in the first sub-pixel part SPX1, as the first switching element TR1 is turned on, the first data signal D1 of the negative polarity (−) may be applied to each of the first sub-pixel electrode PE1 and the second sub-pixel electrode PE2. The voltage level of the first data signal D1 of the negative polarity (−) may be lower than the levels of the first and second common voltages Vcom1, Vcom2. Therefore, as in the case of FIG. 7(a), since the level of the voltage charged to the first liquid crystal capacitor Clc1 is relatively low, the first sub-pixel electrode PE1 may be expressed by low (L). In this case, the second sub-pixel electrode PE2 may be expressed by high (H).

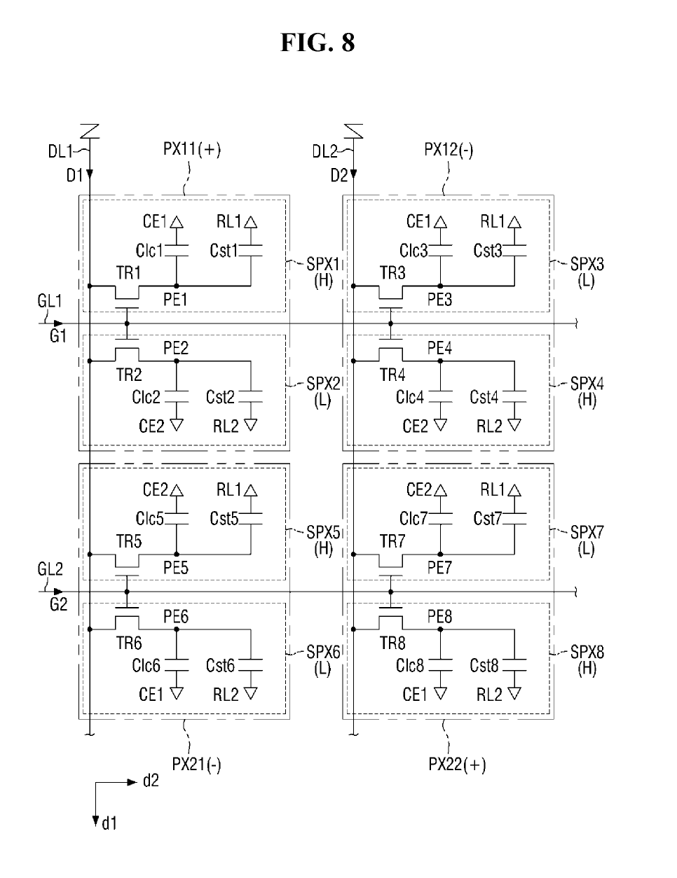

FIG. 8 is a diagram for explaining a driving method of the first to fourth pixel parts PX11, PX12, PX21, PX22 of the display panel illustrated in FIG. 1. However, the first data signal D1, the voltage level of which changes from the positive polarity (+) to the negative polarity (−), is applied to the first data line DL1, and the second data signal D2, the voltage level of which rises from the positive polarity (+) to the negative polarity (−), is applied to the second data line DL2. In an embodiment, as described above with reference to FIG. 7, the level of the first common voltage Vcom1 applied to the first common electrode CE1 may be lower than the level of the second common voltage Vcom2 applied to the second common electrode CE2.

Referring to FIG. 8, the first data signal D1 of the positive polarity (+) is applied to the first pixel part PX11. In an embodiment, since the level of the first common voltage Vcom1 is lower than the level of the second common voltage Vcom2, the level of voltage charged to the first liquid crystal capacitor Clc1 in the first sub-pixel part SPX1 is higher than the level of voltage charged to the second liquid crystal capacitor Clc2 in the second sub-pixel part SPX2. Thus, the first sub-pixel parts SPX1 may be expressed by high (H), and the second sub-pixel part SPX2 may be expressed by low (L).

The second data signal D2 of the negative polarity (−) is applied to the second pixel part PX12. Since the level of the first common voltage Vcom1 is lower than the level of the second common voltage Vcom2, the level of the voltage charged to the third liquid crystal capacitor Clc3 in the third sub-pixel part SPX3 is lower than the level of the voltage charged to the fourth liquid crystal capacitor Clc4 in the fourth sub-pixel part SPX4. Thus, the third sub-pixel part SPX3 may be expressed by low (L), and the fourth sub-pixel part SPX4 may be expressed by high (H).

The first data signal D1, the voltage level of which changes from the positive polarity (+) to the negative polarity (−), is applied to the third pixel part PX21. Therefore, the level of the voltage charged to the fifth liquid crystal capacitor Clc5 in the fifth sub-pixel part SPX5 is higher than the level of voltage charged to the sixth liquid crystal capacitor Clc6 in the sixth sub-pixel part SPX6. Thus, the fifth sub-pixel part SPX5 may be expressed by high (H), and the sixth sub-pixel part SPX6 may be expressed by low (L).

The second data signal D2, the voltage level of which changes from the negative polarity (−) to the positive polarity (+), is applied to the fourth pixel part PX22. Thus, the level of voltage charged to the seventh liquid crystal capacitor Clc7 in the seventh sub-pixel part SPX7 is lower than the level of voltage charged to the eighth liquid crystal capacitor Clc8 in the eighth sub-pixel part SPX8. Thus, the seventh sub-pixel part SPX7 may be expressed by low (L), and the eighth sub-pixel part SPX8 may be expressed by high (H).

In an embodiment, as shown in FIG. 8, the liquid crystal display device may be driven in a dot-inversion mode in which data signals with polarities different from each other are applied for the pixel parts adjacent to each other.

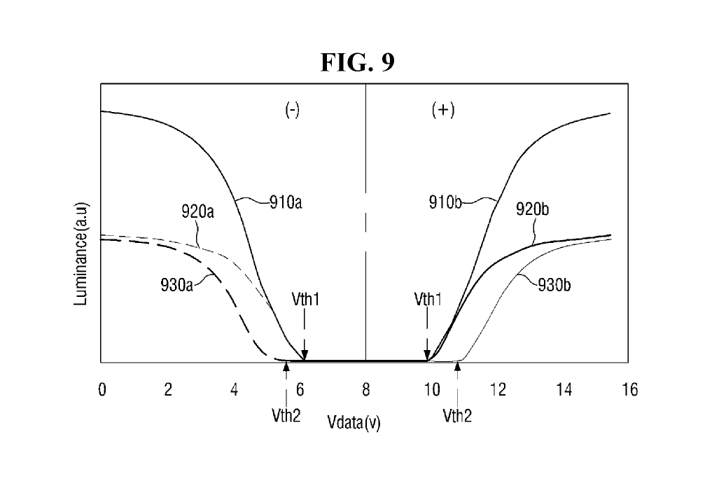

FIGS. 9 to 11 are diagrams for explaining an effect of the liquid crystal display device according to an embodiment of the invention.

FIG. 9 is a graph illustrating a symmetrical condition of the positive polarity (+) and the negative polarity (−) in a luminance curve of a voltage level Vdata of the data signal. In the graph of FIG. 9, 910a illustrates a luminance curve of the first and second sub-pixel parts when the data signal of negative polarity (−) is applied thereto, and 910b illustrates a luminance curve of the two sub-pixels charged with the voltages different from each other when the data signal of positive polarity (+) is applied thereto. In the graph of FIG. 9, 920a illustrates a luminance curve of the sub-pixel part H when the data signal of negative polarity (−) is applied thereto, and 920b illustrates a luminance curve of the sub-pixel part H when the data signal of positive polarity (+) is applied thereto. In the graph of FIG. 9, 930a illustrates a luminance curve of the sub-pixel part L when the data signal of negative polarity (−) is applied thereto, and 930b illustrates a luminance curve of the sub-pixel part L when the data signal of positive polarity (+) is applied thereto.

Referring to FIG. 9, if the first common voltage Vcom1 is about 7.5 V and the second common voltage Vcom2 is approximately 8.5 V, it is understood that a region displaying the black gradation has the voltage level of the data signal between about 6.5 V to about 9.5 V. As an absolute value (e.g., |Vcom1−Vcom2|) of a difference between the first common voltage and the second common voltage increases, a region indicating the black gradation may decrease. Referring to FIG. 9, since a difference between the first and second threshold voltage values Vth1, Vth2 for the liquid crystal layer 30 is clear, the side viewing angle characteristics may be improved.

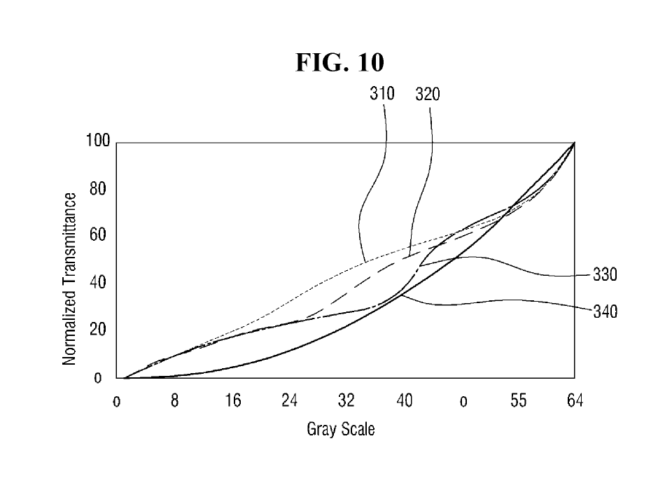

FIG. 10 is a graph illustrating an improvement in side viewing angle of the liquid crystal display device according to an embodiment of the invention. In the graph of FIG. 10, 310 shows a gamma distortion index (“GDI”) of a conventional the liquid crystal display device, and 320 and 330 show GDI of the liquid crystal display device according to an embodiment of the invention. In the graph of FIG. 10, 340 shows a front viewing angle according to an embodiment of the invention, 320 is directed to an embodiment where the level of the first common voltage Vcom1 is about 7.5 V and the level of the second common voltage Vcom2 is about 8.5 V, and 330 is directed to an embodiment where the level of the first common voltage Vcom1 is about 7.5 V and the level of the second common voltage Vcom2 is about 9.5 V. Here, the conventional liquid crystal display device has a structure in which a single pixel part is divided into two sub-pixel parts, and a separate distributing voltage transistor is added to each sub-pixel part thereof.

Referring to FIG. 10, GDI (310) of the conventional liquid crystal display device may be about 0.314, and GDI (320) of the liquid crystal display device according to an embodiment of the invention may be about 0.297. In addition, GDI (330) of the liquid crystal display device according to an embodiment of the invention may be 0.307. As shown in FIG. 10, GDI of the liquid crystal display device according to an embodiment of the invention, where each of the two sub-pixel electrodes is superimposed with or overlapping the common electrodes that receives different common voltages from each other, may be decreased compared to the conventional liquid crystal display device. Accordingly, the side viewing angle of the liquid crystal display device according to an embodiment of the invention may be improved.

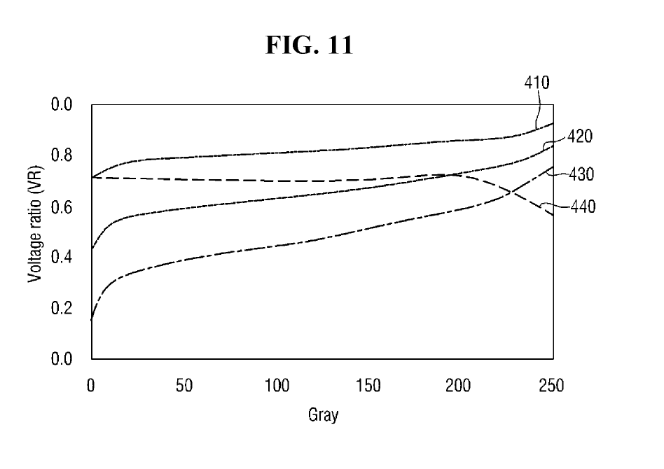

FIG. 11 is a graph illustrating a voltage ratio (“VR”) of the liquid crystal display device according to an embodiment of the invention. In FIG. 11, 410 is directed to an embodiment of the liquid crystal display device according to the invention in which the level of the first common voltage Vcom1 is about 7.5 V and the level of the second common voltage Vcom2 is about 8.0 V. In FIG. 11, 420 is directed to an embodiment of the liquid crystal display device according to the invention in which the level of the first common voltage Vcom1 is about 7.5 V and the level of the second common voltage Vcom2 is about 8.5 V. In FIG. 11, 430 is directed to an embodiment of the liquid crystal display device according to the invention in which the level of the first common voltage Vcom1 is about 7.5 V and the level of the second common voltage Vcom2 is about 8.5 V. In FIG. 11, 440 is directed to an embodiment of a conventional liquid crystal display device.

Referring to FIG. 11, as compared to the conventional liquid crystal display device 440, in embodiments of the liquid crystal display devices 410 to 430 according to the invention, the voltage ratio VR may increase in the high gradation. Thus, in such embodiments of the liquid crystal display devices 410 to 430 according to the invention, both of the sub-pixel part of the high (H) state and the sub-pixel part of the low (L) state may have the similar luminance.

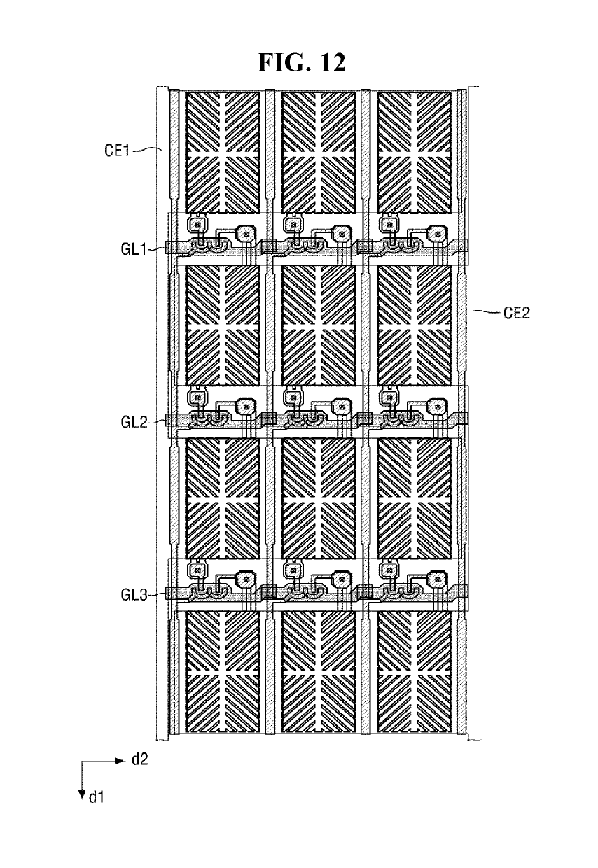

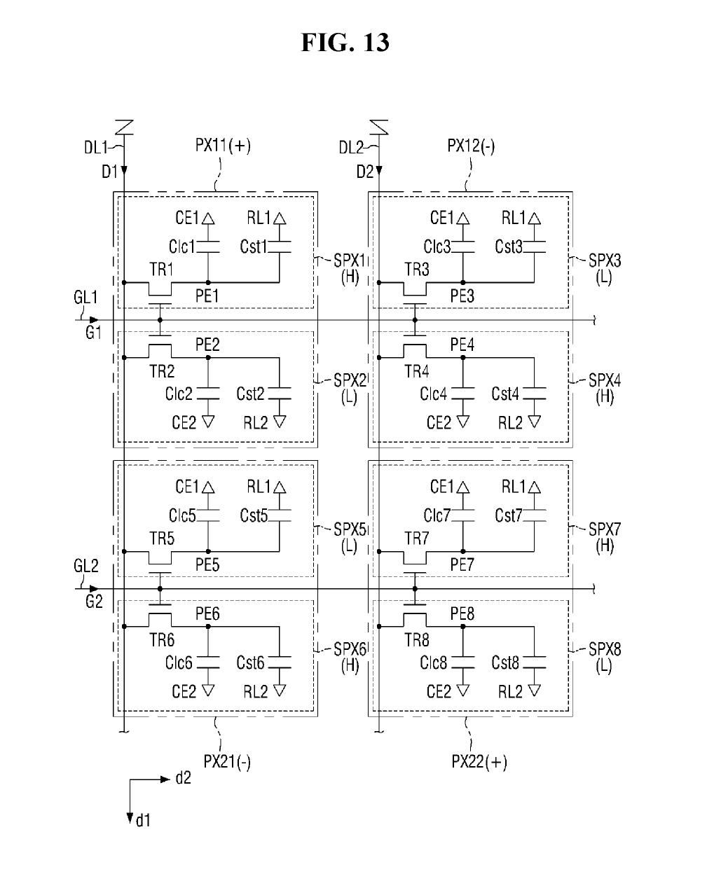

FIG. 12 is a plan view for illustrating a liquid crystal display device according to an alternative embodiment of the invention. FIG. 13 is an equivalent circuit diagram of the first to fourth pixel parts PE11, PE12, PE21, PE22 of the liquid crystal display device illustrated in FIG. 12. The same or like elements shown in FIGS. 12 and 13 have been labeled with the same reference characters as used above to describe the exemplary embodiments of the liquid crystal display device with reference to FIGS. 1 to 11, and any repetitive detailed description thereof will hereinafter be omitted or simplified.

Referring to FIGS. 12 and 13, in an embodiment, a fifth sub-pixel part SPX5 of the third pixel part PE21 may be superimposed with or overlapping at least a part of the first common electrode CE1. The fifth sub-pixel part SPX5 may receive the first common voltage Vcom1 from the first common electrode CE1. In such an embodiment, the sixth sub-pixel part SPX6 may be superimposed with or overlapping at least a part of the second common electrode CE2. The sixth sub-pixel part SPX6 may receive the second common voltage Vcom2 from the second common electrode CE2.

In an embodiment, the first data signal D1, the voltage level of which changes from the positive polarity (+) to the negative polarity (−), is applied to the third pixel part PE21. Therefore, the level of voltage charged to the fifth liquid crystal capacitor Clc5 in the fifth sub-pixel part SPX5 is lower than the level of voltage charged to the sixth liquid crystal capacitor Clc6 in the sixth sub-pixel part SPX6. Thus, the fifth sub-pixel part SPX5 may be expressed by low (L), and the sixth sub-pixel part SPX6 may be expressed by high (H).

A seventh sub-pixel part SPX7 of the fourth pixel part PE22 may be superimposed with or overlapping at least a part of the first common electrode CE1. The seventh sub-pixel part SPX7 may receive the first common voltage Vcom1 from the first common electrode CE1. In such an embodiment, an eighth sub-pixel part SPX8 may be superimposed with or overlapping at least a part of the second common electrode CE2. The eight sub-pixel part SPX8 may receive the second common voltage Vcom2 from the second common electrode CE2.

In an embodiment, the second data signal D2, the voltage level of which changes from the negative polarity (−) to the positive polarity (+), is applied to the fourth pixel part PE22. Thus, the level of voltage charged to the seventh liquid crystal capacitor Clc7 in the seventh sub-pixel part SPX7 is higher than the level of voltage charged to the eighth liquid crystal capacitor Clc8 in the eighth sub-pixel part SPX8. Thus, the seventh sub-pixel part SPX7 may be expressed by high (H), and the eighth sub-pixel part SPX8 may be expressed by low (L).

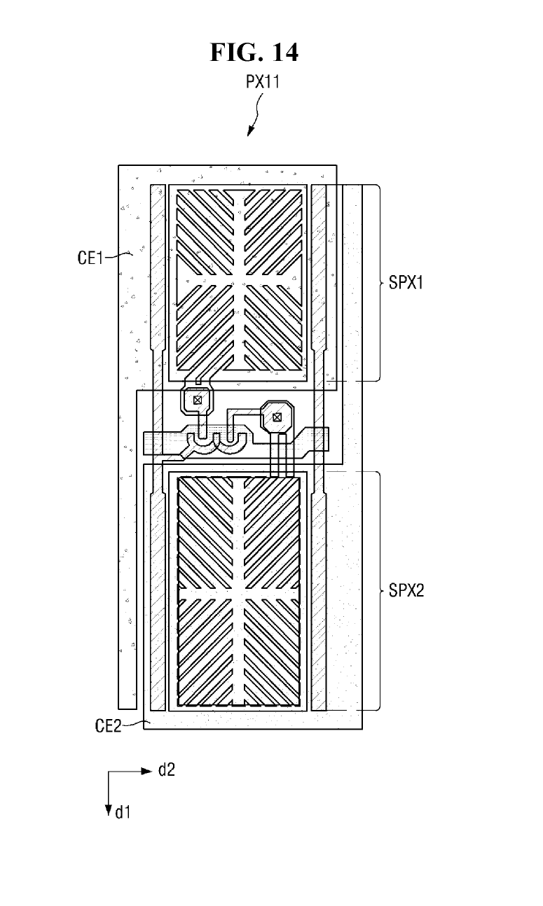

FIG. 14 is a plan view illustrating a first pixel part of a liquid crystal display device according to another alternative embodiment of the invention.

Referring to FIG. 14, in an embodiment of the liquid crystal display device according to the invention, an area of the first sub-pixel part SPX1 may be smaller than an area of the second sub-pixel part SPX2. In such an embodiment, the ratio of the area of the first sub-pixel part SPX1 to the area of the second sub-pixel SPX2 may about 1:1.5.

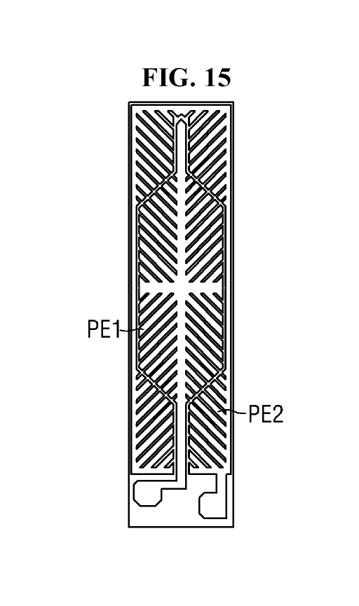

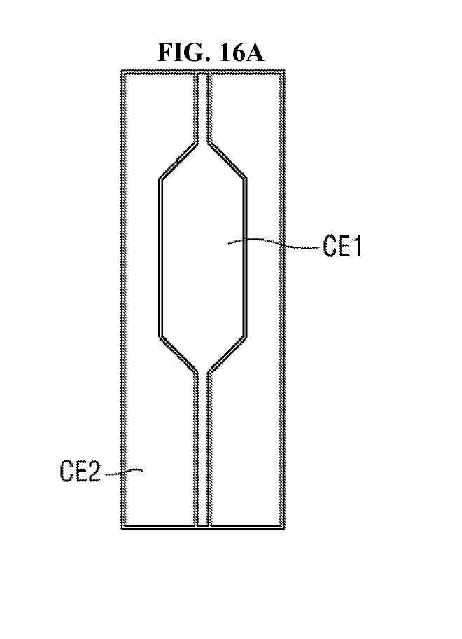

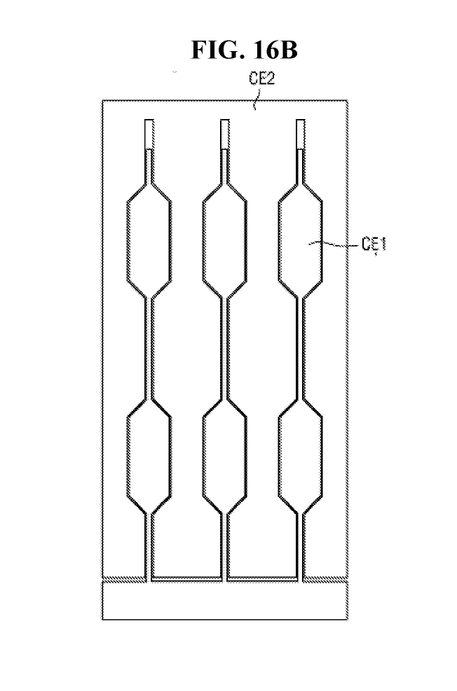

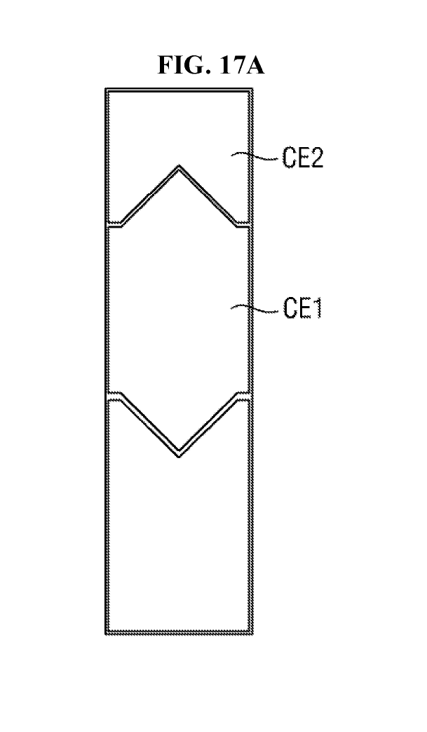

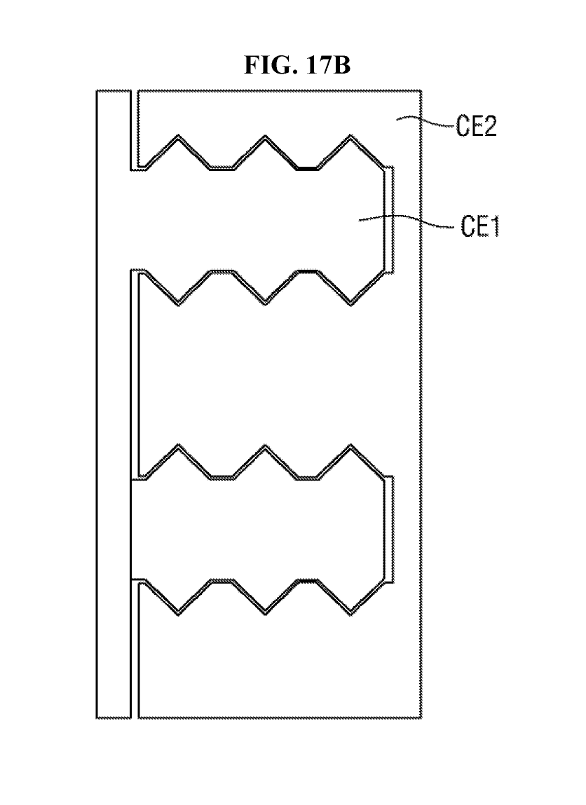

FIG. 15 is a diagram illustrating the first and second sub-pixel electrodes of the liquid crystal display device according to another alternative embodiment of the invention. FIGS. 16A and 16B are diagrams illustrating an alternative embodiment of the first and second common electrodes CE1, CE2 corresponding to the first and second sub-pixel electrodes PE1, PE2 illustrated in FIG. 15. FIGS. 17A and 17B are diagrams illustrating another alternative embodiment of the first and second common electrodes corresponding to the first and second sub-pixel electrodes illustrated in FIG. 15. Although FIGS. 15 through 17 illustrate various embodiments of the sub-pixel electrode and the shape of the common electrode corresponding thereto, a difference in voltage levels applied to the first and second common electrodes CE1, CE2, the type of voltage (e.g., DC voltage), a positional relation with the sub-pixel electrode and the like are substantially the same as those of the embodiments of the liquid crystal display device described above.

In an embodiment, for convenience of description, all of the first sub-pixel electrode PE1, the second sub-pixel electrode PE2, the first common electrode CE1 and the second common electrode CE2 are denoted by the same reference numerals as used to describe the embodiments of the liquid crystal display device shown in FIGS. 1 to 14.

In an embodiment, referring first to FIG. 15, the second sub-pixel electrode PE2 may be disposed to surround the periphery of the first sub-pixel electrode PE1. In such an embodiment, the first and second sub-pixel electrodes PE1, PE2 may be spaced apart from each other by a predetermined distance and may be electrically insulated accordingly.

Referring to FIG. 16A, in an embodiment, first and second common electrodes CE1, CE2 may have a shape corresponding to shapes of the first and second sub-pixel electrodes PE1, PE2 illustrated in FIG. 15. In such an embodiment, as shown in FIG. 16A, the first common electrode CE1 may be disposed inside the second common electrode CE2, while being spaced apart from the second common electrode CE2 by a predetermined distance from to be superimposed with or overlapping the first sub-pixel electrode PE1. In such an embodiment, the second common electrode CE2 may surround the periphery of the first common electrode CE1 to be superimposed with or to overlap the second sub-pixel electrode PE2. With reference to FIG. 16B, the first common electrode CE1 has a structure which relatively extends from the lower part to the upper part, and the second common electrode CE2 has a structure which relatively extends from the upper part to the lower part.

In an alternative embodiment, referring to FIGS. 17A and 17B, the first common electrode CE1 may be disposed inside the second common electrode CE2 to be spaced apart from the second common electrode CE2 by a predetermined distance. The first common electrode CE1 may include a plurality of protrusion patterns that protrudes in the direction of the second common electrode CE2, and the second common electrode CE2 may include a plurality of embossed patterns having a shape corresponding to the protrusion.

While the invention has been particularly illustrated and described with reference to exemplary embodiments thereof, it will be understood by those of ordinary skill in the art that various changes in form and detail may be made therein without departing from the spirit and scope of the invention as defined by the following claims. The exemplary embodiments should be considered in a descriptive sense only and not for purposes of limitation.

What is claimed is:

1. A liquid crystal display device comprising:
a first data line disposed in a first direction;
a first gate line disposed in a second direction different from the first direction; and
a first pixel part connected to the first data line and the first gate line, wherein the first pixel part comprises:
a first sub-pixel part comprising a first sub-pixel electrode overlapping a first common electrode; and
a second sub-pixel part comprising a second sub-pixel electrode overlapping a second common electrode,
wherein
the first sub-pixel part further comprises a first switching element, wherein a gate electrode of the first switching element is connected to the first gate line, an electrode of the first switching element is connected to the first data line, and another electrode of the first switching element is connected to the first sub-pixel electrode, and
the second sub-pixel part further comprises a second switching element, wherein a gate electrode of the second switching element is connected to the first gate line, an electrode of the second switching element is connected to the first data line, and another electrode of the second switching element is connected to the second sub-pixel electrode, and
a voltage level of a voltage applied to the first common electrode is different from a voltage level of a voltage applied to the second common electrode.

2. The liquid crystal display device of claim 1, wherein the voltage level of the voltage applied to the first common electrode and the voltage level of the voltage applied to the second common electrode are substantially constant.

3. The liquid crystal display device of claim 1, wherein the voltage level of the voltage applied to the first common electrode is lower than the voltage level of voltage applied to the second common electrode.

4. The liquid crystal display device of claim 1, wherein
the voltage level of the voltage applied to the first common electrode is about 7.5 volts, and
the voltage level of the voltage applied to the second common electrode is in a range of about 8 volts to about 9.5 volts.

5. The liquid crystal display device of claim 1, further comprising:
a second data line disposed adjacent to the first data line; and
a second pixel part connected to the first gate line and the second data line,
wherein the second pixel part comprises:
a third sub-pixel part comprising a third sub-pixel electrode overlapping the first common electrode; and
a fourth sub-pixel part comprising a fourth sub-pixel electrode overlapping the second common electrode.

6. The liquid crystal display device of claim 5, wherein
the third sub-pixel part further comprises a third switching element, wherein a gate electrode of the third switching element is connected to the first gate line, an electrode of the third switching element is connected to the second data line, and another electrode of the third switching element is connected to the third sub-pixel electrode, and
the fourth sub-pixel part further comprises a fourth switching element, wherein a gate electrode of the fourth switching element is connected to the first gate line, an electrode of the fourth switching element is connected to the second data line, and another electrode of the fourth switching element is connected to the fourth sub-pixel electrode.

7. The liquid crystal display device of claim 5, wherein a polarity of a signal applied from the first data line to the first pixel part is different from a polarity of a signal applied from the second data line to the second pixel part.

8. The liquid crystal display device of claim 5, further comprising:
a second gate line disposed adjacent to the first gate line; and
a third pixel part connected to the first data line and the second gate line,
wherein the third pixel part comprises:
a fifth sub-pixel part comprising a fifth sub-pixel electrode overlapping one of the first common electrode and the second common electrode; and
a sixth sub-pixel part comprising a sixth sub-pixel electrode overlapping the other of the first common electrode and the second common electrode.

9. The liquid crystal display device of claim 8, wherein a polarity of a signal applied from the first data line to the first pixel part is different from a polarity of a signal applied from the first data line to the third pixel part.

10. The liquid crystal display device of claim 8, wherein
the fifth sub-pixel part further comprises a fifth switching element, wherein a gate electrode of the fifth switching element is connected to the second gate line, an electrode of the fifth switching element is connected to the first data line, and another electrode of the fifth switching element is connected to the fifth sub-pixel electrode, and
the sixth sub-pixel part further comprises a sixth switching element, wherein a gate electrode of the sixth switching element is connected to the second gate line, an electrode of the sixth switching element is connected to the first data line, and another electrode of the sixth switching element is connected to the sixth sub-pixel electrode.

11. The liquid crystal display device of claim 1, wherein a ratio of an area of the first sub-pixel electrode to an area of the second sub-pixel electrode is about 1:1.

12. The liquid crystal display device of claim 1, wherein a ratio of an area of the first sub-pixel electrode to an area of the second sub-pixel electrode is about 1:1.5.

13. A liquid crystal display device comprising:
a first substrate;
a second substrate disposed opposite to the first substrate;
a plurality of data lines disposed on the first substrate and extending in a first direction;
a plurality of gate lines disposed on the first substrate and extending in a second direction different from the first direction;
a plurality of pixel parts connected to the plurality of data lines and the plurality of gate lines; and
first and second common electrodes disposed on the second substrate,
wherein
the plurality of pixel parts comprises a first pixel part comprising:
a first sub-pixel part overlapping the first common electrode; and
a second sub-pixel part overlapping the second common electrode, and
a voltage level of a voltage applied to the first common electrode is different from a voltage level of a voltage applied to the second common electrode.

14. The liquid crystal display device of claim 13, wherein the voltage level of the voltage applied to the first common electrode and the voltage level of the voltage applied to the second common electrode are substantially constant.

15. The liquid crystal display device of claim 13, wherein the voltage level of the voltage applied to the first common electrode is lower than the voltage level of the voltage applied to the second common electrode.

16. The liquid crystal display device of claim 13, wherein data signals with polarities different from each other are applied respectively to adjacent pixel parts among the plurality of pixel parts.

17. The liquid crystal display device of claim 13, wherein
the plurality of pixel parts further comprises a second pixel part comprises third and fourth sub-pixel parts which are connected to a second data line disposed adjacent to the first data line, and the first gate line,
wherein
the third sub-pixel part comprises a third sub-pixel electrode overlapping the first common electrode, and
the fourth sub-pixel part comprises a fourth sub-pixel electrode overlapping the second common electrode.

18. The liquid crystal display device of claim 17, wherein
the plurality of pixel parts further comprises a third pixel part comprising fifth and sixth sub-pixel parts, which are connected a second gate line disposed adjacent to the first gate line, and the first data line,
wherein
the fifth sub-pixel part comprises a fifth sub-pixel electrode overlapping the second common electrode, and
the sixth sub-pixel part comprises a sixth sub-pixel electrode overlapping the first common electrode.

19. The liquid crystal display device of claim 17, wherein
the plurality of pixel parts further comprises a third pixel part comprising fifth and sixth sub-pixel parts, which are connected to a second gate line disposed adjacent to the first gate line, and the first data line,
wherein
the fifth sub-pixel part comprises a fifth sub-pixel electrode overlapping the first common electrode, and
the sixth sub-pixel part comprises a sixth sub-pixel electrode overlapping the second common electrode.
